(19) United States
(12) Patent Application Publication
(10) Pub. No.: US 2024/0377211 A1
(43) Pub. Date: Nov. 14, 2024

(54) AUTOMATED ROUTE GENERATION AND FRICTIONLESS ENGAGEMENT SYSTEMS AND METHODS

(71) Applicant: State Farm Mutual Automobile Insurance Company, Bloomington, IL (US)

(72) Inventors: Aaron Williams, Congerville, IL (US); Seth L. Corin, Cumming, GA (US)

(21) Appl. No.: 18/652,173

(22) Filed: May 1, 2024

Related U.S. Application Data
(60) Provisional application No. 63/501,243, filed on May 10, 2023.

(51) Int. Cl. G01C 21/34; G06Q 50/40

(52) U.S. Cl. CPC G01C 21/3484; G01C 21/3423; G06Q 50/40

(57) ABSTRACT

A computer system may be provided. The computer system may include at least one processor. The at least one processor may be programmed to: (i) receive, from a user device, a trip request including a destination location for a trip; (ii) generate, based upon the trip request using an AI model, a route including a plurality of route segments, each of the plurality of route segments associated with a respective type of transportation, wherein the AI model is trained using historical trip records including historical trip data associated with historical trips; (iii) generate a user interface, the user interface including instructions associated with the generated route, the instructions indicating the respective type of transportation to be used for each route segment; and/or (iv) cause the user device to display the generated user interface.

### CROSS-REFERENCE TO RELATED APPLICATIONS

This application claims priority to U.S. Provisional Patent Application No. 63/501,243, filed May 10, 2023, the entire contents and disclosures of which are hereby incorporated herein by reference in its entirety.

### FIELD OF USE

The present disclosure relates to generating transportation routes and, more particularly, to computer-based systems and methods for generating transportation routes using artificial intelligence (AI).

### BACKGROUND

Individuals use mobile devices (e.g., mobile telephones) for a variety of purposes and often carry mobile devices while traveling. Such usage and the carrying of the devices may be a source of data. For example, mobile devices may be equipped to generate data (e.g., telematics data and/or location data) using instruments built into the mobile device, such as an accelerometer or global positioning system (GPS) device. This data obtained from mobile devices may be useful for a variety of applications.

For example, in and around urban environments, consumers may utilize many different transportation types to travel to their destinations. These transportation types may include public transportation, such as commuter trains, buses, and/or trams, and may also include third-party transportation services, such as taxis, rideshare, bikes, scooters, and others. In the future, even more public and private rideshare and autonomous options may be developed. Consumers currently may take many different steps to route plan, schedule, hail, locate, and pay for these transportation services and related services (e.g., insurance), especially if using multiple forms of transportation to reach a destination. For each type of transportation service, purchases may utilize many forms, including purchasing real or digital passes, using payment methods within transportation or other payment style apps, and/or paying with currency.

However, conventional techniques may include inefficiencies, ineffectiveness, encumbrances, and/or other drawbacks as well.

### BRIEF SUMMARY

The present embodiments may relate to, inter alia, systems and methods for improved transportation route generation using artificial intelligence. A system and method may use data collected by travelers to generate a model that may be used to generate the most efficient transportation routes. The generated route may include one or more route segments, each of which may be associated with a different type of transportation. A computer system may train an AI model based on data associated with historical trips. The AI model may be able to output, based upon a destination input by a user and/or a group of users and stored preferences associated with the user, a route for a trip that may include one or more specified types of transportation for respective route segments. The AI model may further output a predicted distance, duration, number of transfers between transportation types, cost, risk and/or safety score, and/or other factors of a potential route based on which the route may or may not be selected. The computer system may further automatically obtain and present credentials (e.g., tickets, purchase confirmations, and/or receipts) for accessing each of the types of transportation. The computer system may further collect telematics data during the trip (e.g., from a user device and/or transportation devices communicatively linked to the user device), which may be used to further train or re-train the AI model and/or determine costs associated with the trip.

In one aspect, a computer system for generating a transportation route using machine learning may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer system may include at least one memory and at least one processor in communication with the at least one memory. The processor may be programmed to: (i) receive, from a user device, a trip request including a destination location for a trip; (ii) generate, based upon the trip request using an AI model, a route including a plurality of route segments, each of the plurality of route segments associated with a respective type of transportation, wherein the AI model is trained using historical trip records including historical trip data associated with historical trips; (iii) generate a user interface, the user interface including instructions associated with the generated route, the instructions indicating the respective type of transportation to be used for each route segment; and/or (iv) cause the user device to display the generated user interface. The computer system may perform additional, less, or alternate functionality, including that discussed elsewhere herein.

In another aspect, a computing device may be provided. The computing device may include at least one processor in communication with at least one memory device and with a user device corresponding to a user. The at least one processor may be configured to receive, from the user device, a trip request including a destination location for a trip. The at least one processor may be further configured to generate, based upon the trip request using an AI model, a route including a plurality of route segments. Each of the plurality of route segments may be associated with a respective type of transportation. The AI model may be trained using historical trip records including historical trip data associated with historical trips. The at least one processor may be further configured to generate a user interface. The user interface may include instructions associated with the generated route. The instructions may indicate the respective type of transportation to be used for each route segment. The at least one processor may be further configured to cause the user device to display the generated user interface. The computing device may perform additional, less, or alternate functionality, including that discussed elsewhere herein.

In another aspect, a computer-implemented method for automated route generation may be provided. The computer-implemented method may be performed by a computing device including at least one processor in communication with at least one memory device and with a user mobile device corresponding to a user. The computer-implemented method may include receiving, from the user device, a trip request including a destination location for a trip. The computer-implemented method may further include generating, based upon the trip request using an AI model, a route including a plurality of route segments. Each of the plurality of route segments may be associated with a respective type of transportation. The AI model may be trained using historical trip records including historical trip data associated with historical trips. The computer-implemented method may further include generating a user interface. The user interface may include instructions associated with the generated route. The instructions may indicate the respective type of transportation to be used for each route segment. The computer-implemented method may further include causing the user device to display the generated user interface. The computer-implemented method may include additional, less, or alternate functionality, including that discussed elsewhere herein.

In another aspect, at least one non-transitory computer-readable storage media having computer-executable instructions embodied thereon may be provided. When executed by a computing device including at least one processor in communication with at least one memory device and with a user device corresponding to a user, the computer-executable instructions may cause the at least one processor to receive, from the user device, a trip request including a destination location for a trip. The computer-executable instructions may further cause the at least one processor to generate, based upon the trip request using an AI model, a route including a plurality of route segments. Each of the plurality of route segments may be associated with a respective type of transportation. The AI model may be trained using historical trip records including historical trip data associated with historical trips. The computer-executable instructions may further cause the at least one processor to generate a user interface. The user interface may include instructions associated with the generated route. The instructions may indicate the respective type of transportation to be used for each route segment. The computer-executable instructions may further cause the at least one processor to cause the user device to display the generated user interface. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary computer system in accordance with an exemplary embodiment of the present disclosure.

FIG. 2 depicts an exemplary client computing device that may be used with the computer system illustrated in FIG. 1.

FIG. 3 depicts an exemplary server system that may be used with the computer system illustrated in FIG. 1.

FIG. 4 depicts an exemplary connected vehicle that may be used with the computer system illustrated in FIG. 1.

FIG. 5A is a flowchart that illustrates an exemplary computer-implemented method for automated route generation using AI.

FIG. 5B is a continuation of the flowchart showing the exemplary computer-implemented method shown in FIG. 5A.

FIG. 5C is a continuation of the flowchart showing the exemplary computer-implemented method shown in FIGS. 5A and 5B.

FIG. 6 is a flowchart that illustrates an exemplary computer-implemented method for group-based trip management.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for automated route generation using an AI model. In exemplary embodiments, the systems and methods may be performed by a server computing device, a bank of server computing devices, and/or other computing devices, which may be in communication with one or more user devices. The generated route includes a prescribed course of travel, which may include one or more route segments that together make up the prescribed course from an origin to a desired destination. Each route segment may be associated with a different type of transportation (e.g., commuter trains, buses, trams, taxis, rideshare, bikes, scooters, and others) for traversing the corresponding route segment.

The server computing device may generate the AI model, which may be used to generate the routes based upon data input by the user (e.g., a desired destination) and other data that may be retrieved by the server computing devices (e.g., geographic data including maps and availability of transportation services at given locations, contextual data such as traffic, weather, and/or road conditions, and user profile data indicating preferences of the user). The AI model may be trained using historical trip records, which may include historical trips and data associated with the historical trips (e.g., historical destinations, routes, types of transportation used, telematics data collected during the trip, costs, user feedback, and/or events such as collisions and/or injuries occurring during the trip). The AI model may determine factors such as a distance, duration, cost, number of transfer points (e.g., between different types of transportation), and/or safety of various potential routes, which may be used to select the route.

The server computing device may cause a mobile application (“app”) executing on the user device to display a user interface for frictionless user engagement during travel. Through the user interface, the user may input a trip request including a desired destination location, which may be input to the AI model to generate the route. The user interface may then display instructions associated with the generated route, which may indicate the respective type of transportation to be used for each route segment. The server computing device may further enable an automatic purchase of transportation services associated with each of the respective types of transportation (e.g., by purchasing tickets, fares, rideshare fees, rentals), and credentials for accessing each of the types of transportation (e.g., tickets, confirmation messages, purchase receipts, and/or codes such as bar codes and/or quick response (QR) codes) may be displayed by the mobile app. The server computing device may generate a consolidated bill for a trip or trips taken during the period, which may include costs associated with transportation services and/or insurance associated with the trip or trips. In some embodiments, the server computing device may identify one or more group members traveling as a group for a trip, and may allocate costs of the trip among the group members.

In some embodiments, the server computing device may collect telematics data (e.g., acceleration, cornering, braking, position, velocity, orientation, speed, location, GPS location or other GPS information, etc.) during trips. Such telematics data may be generated by sensors of the user device, sensors of transportation devices communicatively linked to the user devices, and/or from other sources (e.g., linked rideshare accounts) that may provide telematics data. Such telematics data, along with historical data relating to events (e.g., accidents) occurring during the trips, may be used to train the AI model, for example, to determine a safety and/or generate a risk or loss score (e.g., associated with a likelihood of an injury or financial loss occurring) for a given route. The risk or loss score may by displayed by the mobile app, and may be updated in real time based on telematics data collected during a trip. In some embodiments, the risk score may be used to determine an insurance cost for a trip and/or to generate routes that prioritize safety of the user.

### Retrieving Input Data

In the exemplary embodiment, the server computing device may be configured to retrieve input data that may be used to generate a route. Certain input data (e.g., an origin and/or desired destination, pricing data, traffic data, weather data, and/or road condition data) may be specific to a given trip, while other input data (e.g., user preferences, geographic data, historical trend data) may apply generally to multiple trips. In some embodiments, each user may have a user profile (e.g., associated with a user login account), which may include information associated with the respective user.

In the exemplary embodiment, the server computing device may receive an origin and destination for a requested trip. For example, the server computing device may cause a mobile app executing on the user device to prompt a user to input a desired destination. The server computing device may further cause the mobile app to prompt the user to input an origin for the trip, or may determine the origin of the trip based on the user's current location (e.g., by using GPS to determine a current geolocation of the user device). In some embodiments, the user may further input (e.g., via the mobile application) certain waypoints, or intermediate points between the origin and destination through which the route must pass. In some embodiments, the user may specify a time for the trip (e.g., via the mobile application). For example, the user may request the trip immediately, or may specify a future time for the trip. The future time may be a single instance or may be recurring (e.g., daily or weekly). In some embodiments, the user may be prompted by the mobile app to log into the user's login account prior to receiving a trip request from the user. In some embodiments, the mobile app may include a chatbot functionality, through which the user may request a route and/or other information using text and/or natural language. Such text and/or natural language inputs may be analyzed using AI and/or chatbot programs (e.g., ChatGPT), which in some embodiments may generate text and/or natural language responses to be presented through the mobile app.

In some embodiments, the user may further enter (e.g., via the mobile app) group data, or data indicating that the trip is to be taken as a group. The group data may include information based upon which other group members may be identified, such as names, account usernames, phone numbers, email addresses, images of the other group members, and/or audio recordings, any of which may be submitted via the mobile app. The group data may further include geographic locations of the users (e.g., determined based on locations of respective user devices associated with each group member). Based upon the group data, the server computing device may determine a number of individuals in the group and whether any of the individuals are associated with existing user profiles (e.g., by performing a lookup in the database based upon the input group data). Identifying group members may enable the server computing device to generate a route based upon preferences of the group members as a whole and to enable cost sharing among the group members, as described in further detail below.

In some embodiments, the server computing device may further retrieve geographic data based upon which the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services such as rideshares, bikeshares, and/or electric scooters are available. The geographic data may be retrieved from a database, the Internet (e.g., from third-party mapping services, such as Google Maps), and/or other sources capable of providing such data, and may be periodically or continually updated to reflect a current state.

In some embodiments, the server computing device may further retrieve contextual data, or data describing current or real-time conditions, based upon which the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The geographic data may be retrieved from a database, the Internet (e.g., from third-party mapping services, such as Google Maps), and/or other sources capable of providing such data, and may be periodically or continually updated (e.g., in real time) to reflect current conditions. As described in further detail below, the server computing device may be configured to update generated routes in real time (e.g., after travel has started) if contextual data indicates that conditions have changed from when the route was initially generated.

In some embodiments, the server computing device may further retrieve user profile data. The user profile data may include preferences to use certain types of transportation, age, health information, demographic information, historical trips and trip patterns, historical usage of different types of transportation, frequently visited locations, historical accident information, historical events and/or claims, and/or preferred billing option. The geographic data may be retrieved from a database, the Internet, and/or other sources capable of providing such data. For example, user profiles including user profile data may be stored for each user in the database. The user profile information may be entered by the user (e.g., via a preferences and/or settings interface of the mobile app), automatically compiled based upon historical trips, and/or automatically retrieved from other data sources (e.g., insurance, financial, and/or transportation service accounts linked to the user profile and/or associated with the user). In some embodiments, the mobile app may initially autofill the user profile with automatically compiled user profile information and allow the user to manually make changes to the information.

The user profile data may further include historical telematics data (e.g., acceleration, cornering, braking, position, velocity, orientation, speed, location, GPS location or other GPS information, etc.) associated with previous trips taken by the user. The telematics data may be collected by sensors of the mobile device, sensors of vehicles and/or telematics devices communicatively linked to the mobile device during trips (e.g., via Bluetooth and/or another wired or wireless communication protocol), and/or transportation service accounts (e.g., rideshare accounts) linked to the user profile that may collect and/or store telematics data during trips. The user profile may further include user feedback from previous trips. For example, the mobile app may prompt the user to rate a trip upon completion of the trip, and over time, the server computing device may identify aspects of a trip that are preferred by the user based upon the submitted ratings.

### Building an Artificial Intelligence Model

In the exemplary embodiment, the server computing device may be configured to generate an AI model, referred to herein as a route generating model, that may used to generate routes based upon input data. In some embodiments, the server computing device may generate and/or train the route generating model using a training dataset that includes one or more training variables and/or model parameters, such as historical geographic data, historical contextual data, and historical user profile data (e.g., including historical preferences of users).

In other embodiments, the server computing device may generate the route generating model in a different format. For example, the route generating model may be a function for receiving data (e.g., a desired destination, on origin, geographic data, contextual data, and user profile data) and generating an output for determining a route (e.g., including one more modes or types of transportation) to the desired destination.

The server computing device may be configured to generate the route generating model by analyzing historical trip records including historical trip data (e.g., historical destinations, routes, types of transportation used, telematics data, costs, user feedback, and/or events such as collisions and/or injuries occurring during the trip) associated with historical trips. The server computing device may be configured to perform a statistical analysis of the historical trip records to generate the structure assessment model. For example, for an aspect of a historical trip (e.g., destinations, routes, types of transportation used, telematics data, costs, user feedback, and/or events such as collisions and/or injuries that occurred during the trip), the server computing device may identify historical trip records associated with the aspect and generate model parameters (e.g., by identifying other parameters held in common among the identified historical trip records). For example, the server computing device may identify features correlated with a particular historical pattern of a user traveling between a certain origin and destination, and which routes and types of transportation were used for these historical trips. In other embodiments, the server computing device may be configured to perform a different analysis that is suitable to generate the route generating model.

The route generating model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, the greater the weighting factor the greater the importance the server computing device will associate with that variable when tuning the model. Likewise, the smaller the weighting factor the lesser the importance that the server computing device will associate with the variable when tuning the model. In some embodiments, the server computing device may weight variables associated with the historical trip records greater than any other model training variables.

In some embodiments, the server computing device may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical image records are created and added to the subset training dataset. The server computing device may generate a training dataset including less than a particular number (e.g., five or three) model training variables, for example.

### Generating a Route Including One or More Types of Transportation

In the exemplary embodiment, the server computing device may be further configured to generate routes based upon input data using the AI model trained using historical trip data. The route may include one or more route segments, which together form a continuous path from the origin to the desired destination. The route segments of a given route may be associated with different types of transportation. For example, a generated route may include three route segments, each with a specific type of transportation (e.g., a rideshare, a bus or train, and a bike or electric scooter). The server computing device may select the route segments based at least in part upon availability of these different types of transportation at different locations and at the particular time, and in turn, the server computing device may be configured to select a transportation type to be used for each route segment of the route. The server computing device may select the route segments and transportation type associated with each route segment using the AI model based upon the input data described above (e.g., user profile data, group data, geographic data, and/or contextual data) and other intermediate factors that are described in further detail below. In some embodiments, the server computing device may update and/or make changes to the route in real time (e.g., after the trip has started) based on new data (e.g., data indicating traffic conditions have changed and/or service outages have occurred at a given location).

In some embodiments, the route may be generated by the AI model based upon the input data and further based upon intermediate factors that may be determined based upon the input data (e.g., using the AI model). These intermediate factors may include, for example, user preferences as determined by trends over time, predicted trip durations associated with different potential routes, predicted trip lengths associated with different potential routes, predicted trip costs (e.g., rental costs, fares, and/or insurance costs) associated with different potential routes, number of transfers, stops, or changes in transportation service type, safety and/or risk associated with different potential routes, insurance costs associated with potential routes, predicted carbon emissions associated with different potential routes, and/or other factors that may vary depending on the specific route selected. The server computing device may select the generated route, and its route segments and corresponding types of transportation, based in part upon optimizing one or more of these intermediate factors. In some embodiments, the server computing device may generate multiple routes that prioritize different ones of these factors (e.g., a shortest distance and a shortest predicted duration), and the user may select from among the generated routes.

In some embodiments, to generate the route, the server computing device may consider user preferences as determined by trends over time. For example, if a user has historically preferred to travel by vehicle, the generated route may utilize rideshares, busses, and/or trains rather than bikes, scooters, and/or walking. In some embodiments, the server computing device may infer or predict preferences of the user based on user profile data. For example, the server computing device may determine that an older user is less likely to prefer transportation types that require physical exertion (e.g., biking and/or walking). Further preferences that may be considered include historical patterns indicating the user desires to decrease costs, decrease travel time, decrease travel distance, reduce a number of transfers, stops, or changes in transportation service type, reduce risk or increase safety, reduce insurance costs, reduce carbon emissions, and/or achieve other objectives with respect to travel. For example, if a user has historically opted to travel a route that is considered the safest even which such an option would result in a higher cost, the server computing device may give more weight to safety or risk when selecting a route (e.g., by selecting transportation types and/or locations through which to travel that are considered to be safer).

In some embodiments, the server computing device may compute a predicted cost associated with the trip, which may include costs associated with purchasing transportation services (e.g., transit tickets, rideshares, and/or bike or electric scooter rentals) and/or costs associated with insurance. For example, the server computing device may compute (e.g., using the AI model) a risk score associated with different possible routes. The risk or loss score may be determined based upon, for example, vehicle type, geographic location, driver history, service provider being used, driver-specific risk scores for the vehicle being used (e.g., for customer, rideshare driver, and/or autonomous vehicle), choice of route within neighborhoods (e.g., whether the user is comfortable with riskier locations and/or unfamiliar with the risk of a location), passenger-specific risk score (e.g., based on previous interactions and/or cumulative/ratings provided by driver of rideshare and/or claims behavior), and/or insurer-determined knowledge relating to risks of certain locations along the potential route. The risk score may correspond to a likelihood of injury or financial loss occurring for a selected route, and may be used (e.g., by the server computing device) to compute an insurance premium for a route. This insurance premium may be factored in when determining a cost associated with a route. For example, consider two potential routes: Route A and Route B. Route A has a lower transportation service cost (e.g., transit tickets, rideshares, and/or bike or electric scooter rental costs) than Route B, but has a higher risk score and therefore a higher associated insurance cost than Route B. Accordingly, if the sum of the transportation service cost and insurance cost of Route A is greater than the sum of the transportation service cost and insurance cost of Route B, Route B may be selected despite Route B having a higher transportation service cost. Accordingly, factoring insurance costs when selecting a route may result in safer travel patterns for the user over time while reducing overall costs of travel for the user.

In the exemplary embodiment, the server computing device may be configured to generate a user interface and cause the user device to display the user interface (e.g., within the mobile app). The user interface may include instructions associated with the generated route. For example, the instructions may indicate the respective type of transportation to be used for each route segment. In some embodiments, such instructions may include text and/or language generated using AI and/or chatbot programs (e.g., ChatGPT).

### Scheduling Transportation Based Upon Generated Routes

In the exemplary embodiment, the server computing device may be configured to schedule transportation based on determined routes. Scheduling transportation may include, for example, automatically purchasing mass transit tickets, hailing and paying for taxi cabs and/or rideshare services, and/or renting bikes and/or electric scooters for each relevant route segment of the generated route. The server computing device may be further configured to handle payment for each of the scheduled transportation services, as described in further detail below.

For example, as the user traverses the generate route, the server computing device may cause mobile app executing on the user device to display information and/or credentials (e.g., tickets and/or rideshare or rental purchase confirmations). The displayed information may include directions, instructions on which transportation to board, real time updates made to the route (e.g., made based upon new information), and/or, instructions on how to display credentials needed to access transportation services in cases in which the mobile app does not automatically display such credentials. For example, tickets or other credentials may automatically be added to a mobile wallet (e.g., Apple Wallet or other digital wallet), and the mobile app may prompt the user to access the tickets via the mobile wallet. Timing of when the mobile app displays the information may be determined based upon a current location of the user. For example, when the server computing device determines that the user is approaching a transfer point to a new route segment and type of transportation, the mobile app may display instructions for the transfer (e.g., which vehicle to board) and credentials needed to access the next transportation service. In some embodiments, such instructions may include text and/or language generated using AI and/or chatbot programs (e.g., ChatGPT).

In some embodiments the server computing device may be configured to collect information (e.g., telematics data) from sensors (e.g., of the user device, of tracking or identifier tags and/or vehicles communicatively linked to the mobile device). The server computing device may use this collected data to further understand user behavior and to further build and refine the AI model. In some embodiments, the server computing device may be further configured to generate a real-time risk score based in part upon telematics data collected during the trip. The risk score may be used to determine and/or adjust an insurance cost associated with the trip, and may be used to modify the route. For example, if the server determines based on telematics data that a currently-used transportation method is unsafe or less-safe than a stored threshold (e.g., a rideshare currently utilized is driving in an unsafe manner), the server computing device may generate an updated route and/or cause the mobile app to instruct the user to switch to end the currently used service and switch to a different vehicle.

In some embodiments, the server computing device may facilitate payment for the trip (e.g., including the used transportation services and/or insurance) via the app. For example, in some embodiments, the server computing device may generate a consolidated bill (e.g., for a trip or for trips during a predefined period), which the user may be prompted to pay via the mobile app. In some embodiments, the payment may automatically be deducted from a pre-paid account or other financial account linked to the user's profile. In some embodiments, payments may be subscription based, with the user being periodically billed a subscription amount. This subscription amount may be determined and/or periodically adjusted based on the user's historical transportation usage.

In some embodiments, for trips undertaken by a group of users, the server computing device may facilitate cost sharing among the members of the group. For example, in some embodiments, the server computing device may divide a cost of the trip among the group members. The cost may be divided evenly, or the cost allocated to each user based upon individual factors. For example, a user that qualified for discounts (e.g., a senior discount for mass transit services and/or a loyalty discount for rideshares) may be allocated less of the cost, while a user that is more expensive to insure may be allocated more of the cost. Group members having user profiles may be billed their respective shares of the trip cost via their account as described above. In some embodiments, a request for reimbursement may be generated for group members (e.g., those not having a profile set up) through a third-party payment service (e.g., CashApp, PayPal, Venmo, and/or Zelle).

At least one of the technical problems addressed by this system may include: (i) inability of a computing device to generate a route having multiple route segments associated with different types of transportation using an AI model trained based upon historical trip data; (ii) inability of a computing device to generate a route with different types of transportation selected based on user preferences using an AI model trained based upon historical trip data including data specifying types of transportation used for the historical trips of the user; (iii) inability of a computing device to determine a safety or risk level of a route having multiple route segments associated with different types of transportation using an AI model trained based upon historical trip data (e.g., historical destinations, routes, types of transportation used, telematics data, costs, user feedback, and/or events such as collisions and/or injuries occurring during the trip); (iv) inability of a user interface to display instructions associated with a route having multiple route segments associated with different types of transportation using an AI model trained based upon historical trip data; (v) inability of a computing device to provide a user interface that automatically displays credentials in real time to access different types of transportation of a route having multiple route segments associated with different types of transportation; and/or (vi) inability of a computing device to collect telematics data for a trip by communicatively pairing with multiple transportation during a trip.

A technical effect of the systems and processes described herein may be achieved by performing at least one of the following steps: (i) receiving, from a user device, a trip request including a destination location for a trip; (ii) generating, based upon the trip request using an AI model, a route including a plurality of route segments, each of the plurality of route segments associated with a respective type of transportation, wherein the AI model is trained using historical trip records including historical trip data associated with historical trips; (iii) generating a user interface, the user interface including instructions associated with the generated route, the instructions indicating the respective type of transportation to be used for each route segment; and/or (iv) causing the user device to display the generated user interface.

The technical effect achieved by this system may be at least one of: (i) ability for a computing device to generate a route having multiple route segments associated with different types of transportation using an AI model trained based upon historical trip data; (ii) ability for a computing device to generate a route with different types of transportation selected based on user preferences using an AI model trained based upon historical trip data including data specifying types of transportation used for the historical trips of the user; (iii) ability for a computing device to determine a safety or risk level of a route having multiple route segments associated with different types of transportation using an AI model trained based upon historical trip data (e.g., historical destinations, routes, types of transportation used, telematics data, costs, user feedback, and/or events such as collisions and/or injuries occurring during the trip); (iv) ability for a user interface to display instructions associated with a route having multiple route segments associated with different types of transportation using an AI model trained based upon historical trip data; (v) ability for a computing device to provide a user interface that automatically displays credentials in real time to access different types of transportation of a route having multiple route segments associated with different types of transportation; and/or (vi) ability for a computing device to collect telematics data for a trip by communicatively pairing with multiple transportation during a trip.

### Exemplary Transportation Analytics System

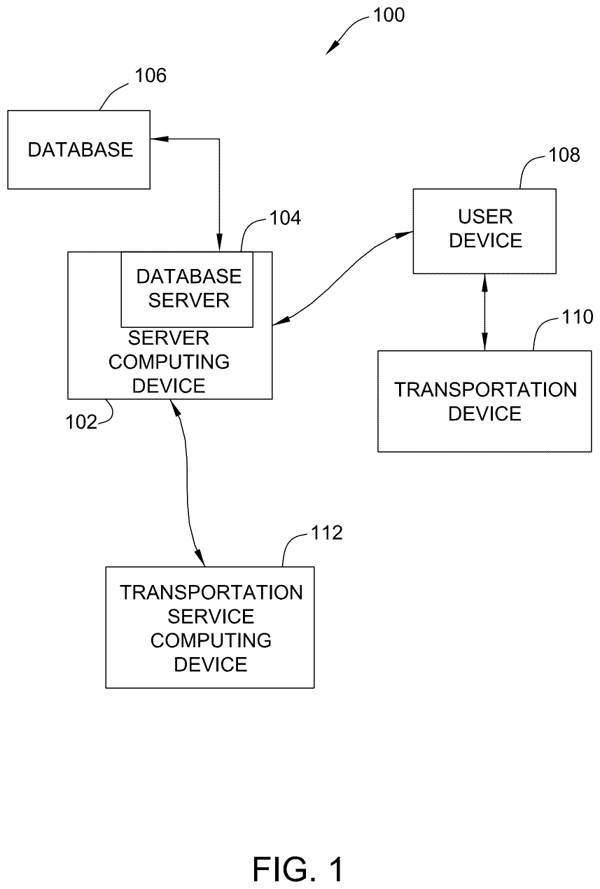

FIG. 1 depicts an exemplary computer system 100 for the present disclosure. Computer system 100 may include a server computing device 102 (which may include one or more computing devices and/or one or more processors) including a database server 104. Server computing device 102 may be in communication with a database 106 and/or one or more user devices 108 associated with one or more users. In some embodiments, user devices 108 may be configured to communicatively link (e.g., via Bluetooth and/or another wireless or wired connection) to transportation devices 110. Server computing device 102 may be in further communication with one or more transportation service computing devices 112.

In the exemplary embodiment, server computing device 102 may be configured to retrieve input data that may be used to generate a route. Certain input data (e.g., an origin and/or desired destination, pricing data, traffic data, weather data, and/or road condition data) may be specific to a given trip, while other input data (e.g., user preferences, geographic data, historical trend data) may apply generally to multiple trips. In some embodiments, each user may have a user profile (e.g., associated with a user login account), which may include information associated with the respective user.

In the exemplary embodiment, server computing device 102 may receive an origin and destination for a requested trip. For example, server computing device 102 may cause a mobile app executing on user device 108 to prompt a user to input a desired destination. Server computing device 102 may further cause the mobile app to prompt the user to input an origin for the trip, or may determine the origin of the trip based on the user's current location (e.g., by using GPS to determine a current geolocation of user device 108). In some embodiments, the user may further input (e.g., via the mobile application) certain waypoints, or intermediate points between the origin and destination through which the route must pass. In some embodiments, the user may specify a time for the trip (e.g., via the mobile application). For example, the user may request the trip immediately, or may specify a future time for the trip. The future time may be a single instance or may be recurring (e.g., daily or weekly). In some embodiments, the user may be prompted by the mobile app to log into the user's login account prior to receiving a trip request from the user. In some embodiments, the mobile app may include a chatbot functionality, though which the user may request a route and/or other information using text and/or natural language. Such text and/or natural language inputs may be analyzed using AI and/or chatbot programs (e.g., ChatGPT), which in some embodiments may generate text and/or natural language responses to be presented through the mobile app.

In some embodiments, the user may further enter (e.g., via the mobile app) group data, or data indicating that the trip is to be taken as a group. The group data may include information based upon which other group members may be identified, such as names, account usernames, phone numbers, email addresses, images of the other group members (e.g., photo of the group and image analysis is used to identify the members of the group), and/or audio recordings, any of which may be submitted via the mobile app. The group data may further include geographic locations of the users (e.g., determined based on locations of respective user devices associated with each group member). Based upon the group data, server computing device 102 may determine a number of individuals in the group and whether any of the individuals are associated with existing user profiles (e.g., by performing a lookup in database 106 based upon the input group data). Identifying group members may enable server computing device 102 to generate a route based upon preferences of the group members as a whole and to enable cost sharing among the group members, as described in further detail below.

In some embodiments, server computing device 102 may further retrieve geographic data based upon which the route may be generated. The geographic data may include data describing topography, locations or thoroughfares such as highways, roads, bike paths, trails, and sidewalks, mass transit routes, safety statistics (e.g., rates of traffic collisions and/or crime), and zones in which certain transportation services such as rideshares, bikeshares, and/or electric scooters are available. The geographic data may be retrieved from database 106, the Internet (e.g., from third-party mapping services, such as Google Maps), transportation service computing device 112, and/or other sources capable of providing such data, and may be periodically or continually updated to reflect a current state.

In some embodiments, server computing device 102 may further retrieve contextual data, or data describing current or real-time conditions, based upon which the route may be generated. The contextual data may include data describing traffic conditions, road conditions (e.g., construction), major events that may affect traffic flow (e.g., locations of conventions, concerts and/or sporting events), weather, time of day, time of year, or other conditions that may affect travel. The geographic data may be retrieved from database 106, the Internet (e.g., from third-party mapping services, such as Google Maps), transportation service computing device 112, and/or other sources capable of providing such data, and may be periodically or continually updated (e.g., in real time) to reflect current conditions. As described in further detail below, server computing device 102 may be configured to update generated routes in real time (e.g., after travel has started) if contextual data indicates that conditions have changed from when the route was initially generated.

In some embodiments, server computing device 102 may further retrieve user profile data. The user profile data may include preferences to use certain types of transportation, age, health information, demographic information, historical trips and trip patterns, historical usage of different types of transportation, frequently visited locations, historical accident information, historical events and/or claims, and/or preferred billing option. The geographic data may be retrieved from database 106, the Internet, transportation service computing device 112, and/or other sources capable of providing such data. For example, user profiles including user profile data may be stored for each user in database 106. The user profile information may be entered by the user (e.g., via a preferences and/or settings interface of the mobile app), automatically compiled based upon historical trips, and/or automatically retrieved from other data sources (e.g., insurance, financial, and/or transportation service accounts linked to the user profile and/or associated with the user). In some embodiments, the mobile app may initially autofill the user profile with automatically compiled user profile information and allow the user to manually make changes to the information. The user profile data may further include historical telematics data (e.g., acceleration, cornering, braking, position, velocity, orientation, speed, location, GPS location or other GPS information, etc.) associated with previous trips taken by the user. The telematics data may be collected by sensors of the mobile device, sensors of transportation devices 110 and/or telematics devices communicatively linked to the mobile device during trips (e.g., via Bluetooth and/or another wired or wireless communication protocol), and/or transportation service accounts (e.g., rideshare accounts) linked to the user profile that may collect and/or store telematics data during trips. The user profile may further include user feedback from previous trips. For example, the mobile app may prompt the user to rate a trip upon completion of the trip, and over time, server computing device 102 may identify aspects of a trip that are preferred by the user based upon the submitted ratings.

In the exemplary embodiment, server computing device 102 may be configured to generate an AI model, referred to herein as a route generating model, that may used to generate routes based upon input data. In some embodiments, server computing device 102 may generate and/or train the route generating model using a training dataset that includes one or more training variables and/or model parameters, such as historical geographic data, historical contextual data, and historical user profile data (e.g., including historical preferences of users).

In other embodiments, server computing device 102 may generate the route generating model in a different format. For example, the route generating model may be a function for receiving data (e.g., a desired destination, on origin, geographic data, contextual data, and user profile data) and generating an output for determining a route (e.g., including one more modes or types of transportation) to the desired destination.

Server computing device 102 may be configured to generate the route generating model by analyzing historical trip records including historical trip data (e.g., historical destinations, routes, types of transportation used, telematics data, costs, user feedback, and/or events such as collisions and/or injuries occurring during the trip) associated with historical trips. Server computing device 102 may be configured to perform a statistical analysis of the historical trip records to generate the structure assessment model. For example, for an aspect of a historical trip (e.g., destinations, routes, types of transportation used, telematics data, costs, user feedback, and/or events such as collisions and/or injuries that occurred during the trip), server computing device 102 may identify historical trip records associated with the aspect and generate model parameters (e.g., by identifying other parameters held in common among the identified historical trip records). For example, server computing device 102 may identify features correlated with a particular historical pattern of a user traveling between a certain origin and destination, and which routes and types of transportation were used for these historical trips. In other embodiments, server computing device 102 may be configured to perform a different analysis that is suitable to generate the route generating model.

The route generating model may be associated with and/or include a parametric engine. The parametric engine represents a relationship between input data such as training variables and/or predicted outputs. The training variables may be parameterized allowing the parametric engine to be tuned to generate accurate outputs. Parameterized training variables may be weighted using weighting coefficients. The parametric engine may be tuned to determine a magnitude and/or a direction of the weighting coefficients. Tuning may include iteratively using the parametric engine to generate model outputs that correspond to an actual event, such as a historical trip, while adjusting the magnitude and direction of the weight coefficients until the error between the model output and the actual event is reduced to an acceptable level. Tuning may be performed in addition to, and/or in combination with, training the model using historical data.

The parametric engine may use the weighted coefficients to rank an importance or influence of a model training variable. For example, the greater the weighting factor the greater the importance server computing device 102 will associate with that variable when tuning the model. Likewise, the smaller the weighting factor the lesser the importance that server computing device 102 will associate with the variable when tuning the model. In some embodiments, server computing device 102 may weight variables associated with the historical trip records greater than any other model training variables.

In some embodiments, server computing device 102 may use a reduced number of training variables (e.g., one or more training variables) that have the greatest weighting factors (e.g., the variables that are ranked with the most importance). The reduced and more focused training dataset, including the training variables with the greatest weights, decreases computational load and will have decreased model training time allowing the model to be more quickly updated as more historical image records are created and added to the subset training dataset. Server computing device 102 may generate a training dataset including less than a particular number (e.g., five or three) model training variables, for example.

In the exemplary embodiment, server computing device 102 may be further configured to generate routes based upon input data using the AI model trained using historical trip data. The route may include one or more route segments, which together form a continuous path from the origin to the desired destination. The route segments of a given route may be associated with different types of transportation. For example, a generated route may include three route segments, each with a specific type of transportation (e.g., a rideshare, a bus or train, and a bike or electric scooter). Server computing device 102 may select the route segments based at least in part upon availability of these different types of transportation at different locations, and in turn, server computing device 102 may be configured to select a transportation type to be used for each route segment of the route. Server computing device 102 may select the route segments and transportation type associated with each route segment using the AI model based upon the input data described above (e.g., user profile data, group data, geographic data, and/or contextual data) and other intermediate factors that are described in further detail below. In some embodiments, server computing device 102 may update and/or make changes to the route in real time (e.g., after the trip has started) based on new data (e.g., data indicating traffic conditions have changed and/or service outages have occurred at a given location).

In some embodiments, the route may be generated by the AI model based upon the input data and further based upon intermediate factors that may be determined based upon the input data (e.g., using the AI model). These intermediate factors may include, for example, user preferences as determined by trends over time, predicted trip durations associated with different potential routes, predicted trip lengths associated with different potential routes, predicted trip costs (e.g., rental costs, fares, and/or insurance costs) associated with different potential routes, number of transfers, stops, or changes in transportation service type, safety and/or risk associated with different potential routes, insurance costs associated with potential routes, predicted carbon emissions associated with different potential routes, and/or other factors that may vary depending on the specific route selected. Server computing device 102 may select the generated route, and its route segments and corresponding types of transportation, based in part upon optimizing one or more of these intermediate factors. In some embodiments, server computing device 102 may generate multiple routes that prioritize different ones of these factors (e.g., a shortest distance and a shortest predicted duration), and the user may select from among the generated routes.

In some embodiments, to generate the route, server computing device 102 may consider user preferences as determined by trends over time. For example, if a user has historically preferred to travel by vehicle, the generated route may utilize rideshares, busses, and/or trains rather than bikes, scooters, and/or walking. In some embodiments, server computing device 102 may infer or predict preferences of the user based on user profile data. For example, server computing device 102 may determine that an older user is less likely to prefer transportation types that require physical exertion (e.g., biking and/or walking). Further preferences that may be considered include historical patterns indicating the user desires to decrease costs, decrease travel time, decrease travel distance, reduce the number of transfers, stops, or changes in transportation service type, reduce risk or increase safety, reduce insurance costs, reduce carbon emissions, and/or achieve other objectives with respect to travel. For example, if a user has historically opted to travel a route that is considered the safest even which such an option would result in a higher cost, server computing device 102 may give more weight to safety or risk when selecting a route (e.g., by selecting transportation types and/or locations through which to travel that are considered to be safer).

In some embodiments, server computing device 102 may compute a predicted cost associated with the trip, which may include costs associated with purchasing transportation services (e.g., transit tickets, rideshares, and/or bike or electric scooter rentals) and/or costs associated with insurance. For example, server computing device 102 may compute (e.g., using the AI model) a risk score associated with different possible routes. The risk score may be determined based upon, for example, vehicle type, geographic location, driver history, service provider being used, driver-specific risk scores for the vehicle being used (e.g., for customer, rideshare driver, and/or autonomous vehicle), choice of route within neighborhoods (e.g., whether the user is comfortable with riskier locations based upon historical accidents and injuries and/or unfamiliar with the risk of a location), passenger-specific risk score (e.g., based on previous interactions and/or cumulative/ratings provided by driver of rideshare and/or claims behavior), and/or insurer-determined knowledge relating to risks of certain locations along the potential route. The risk score may correspond to a likelihood of injury or financial loss occurring for a selected route, and may be used (e.g., by server computing device 102) to compute an insurance premium for a route. This insurance premium may be factored in when determining a cost associated with a route. For example, consider two potential routes: Route A and Route B. Route A has a lower transportation service cost (e.g., transit tickets, rideshares, and/or bike or electric scooter rental costs) than Route B, but has a higher risk score and therefore a higher associated insurance cost than Route B. Accordingly, if the sum of the transportation service cost and insurance cost of Route A is greater than the sum of the transportation service cost and insurance cost of Route B, Route B may be selected in spite of Route B having a higher transportation service cost. Accordingly, factoring insurance costs when selecting a route may result in safer travel patterns for the user over time while reducing overall costs of travel for the user.

In the exemplary embodiment, server computing device 102 may be configured to generate a user interface and cause user device 108 to display the user interface (e.g., within the mobile app). The user interface may include instructions associated with the generated route. For example, the instructions may indicate the respective type of transportation to be used for each route segment. In some embodiments, such instructions may include text and/or language generated using AI and/or chatbot programs (e.g., ChatGPT).

In the exemplary embodiment, the server computing device may be configured to schedule transportation based on determined routes. Scheduling transportation may include, for example, automatically purchasing mass transit tickets, hailing and paying for taxi cabs and/or rideshare services, and/or renting bikes and/or electric scooters for each relevant route segment of the generated route. The server computing device may be further configured to handle payment for each of the scheduled transportation services, as described in further detail below.

For example, as the user traverses the generate route, the server computing device may cause mobile app executing on user device 108 to display information and/or credentials (e.g., tickets and/or rideshare or rental purchase confirmations). The displayed information may include directions, instructions on which transportation to board, real time updates made to the route (e.g., made based upon new information), and/or, instructions on how to display credentials needed to access transportation services in cases in which the mobile app does not automatically display such credentials. For example, tickets or other credentials may automatically be automatically added to a mobile wallet (e.g., Apple Wallet or other digital wallet), and the mobile app may prompt the user to access the tickets via the mobile wallet. Timing of when the mobile app displays the information may be determined based upon a current location of the user. For example, when the server computing device determines that the user is approaching a transfer point to a new route segment and type of transportation, the mobile app may display instructions for the transfer (e.g., which vehicle to board) and credentials needed to access the next transportation service. In some embodiments, such instructions may include text and/or language generated using AI and/or chatbot programs (e.g., ChatGPT).

In some embodiments the server computing device may be configured to collect information (e.g., telematics data) from sensors (e.g., of user device 108, of tracking or identifier tags and/or transportation devices 110 communicatively linked to the mobile device). The server computing device may use this collected data to further understand user behavior and to further build and refine the AI model. In some embodiments, the server computing device may be further configured to generate a real-time risk score based in part upon telematics data collected during the trip. The risk score may be used to determine and/or adjust an insurance cost associated with the trip, and may be used to modify the route. For example, if the server determines based on telematics data that a currently-used transportation method is unsafe or does not meet a threshold level of safety (e.g., a rideshare currently utilized is driving in an unsafe manner), the server computing device may generate an updated route and/or cause the mobile app to instruct the user to switch to end the currently used service and switch to a different vehicle.

In some embodiments, the server computing device may facilitate payment for the trip (e.g., including the used transportation services and/or insurance) via the app. For example, in some embodiments, the server computing device may generate a consolidated bill (e.g., for a trip or for trips during a predefined period), which the user may be prompted to pay via the mobile app. In some embodiments, the payment may automatically be deducted from a pre-paid account or other financial account linked to the user's profile. In some embodiments, payments may be subscription based, with the user being periodically billed a subscription amount. This subscription amount may be determined and/or periodically adjusted based on the user's historical transportation usage.

In some embodiments, for trips undertaken by a group of users, the server computing device may facilitate cost sharing among the members of the group. For example, in some embodiments, the server computing device may divide a cost of the trip among the group members. The cost may be divided evenly, or the cost allocated to each user based upon individual factors. For example, a user that qualified for discounts (e.g., a senior discount for mass transit services and/or a loyalty discount for rideshares) may be allocated less of the cost, while a user that is more expensive to insure may be allocated more of the cost. Group members having user profiles may be billed their respective shares of the trip cost via their account as described above. For registered users having a user profile, funds may be automatically transferred from an identified account associated with the user to satisfy the cost allocated to the registered user. In some embodiments, a request for reimbursement may be generated for group members (e.g., those not having a profile set up) through a third-party payment service (e.g., CashApp, PayPal, Venmo, and/or Zelle).

### Exemplary Client Computing Device

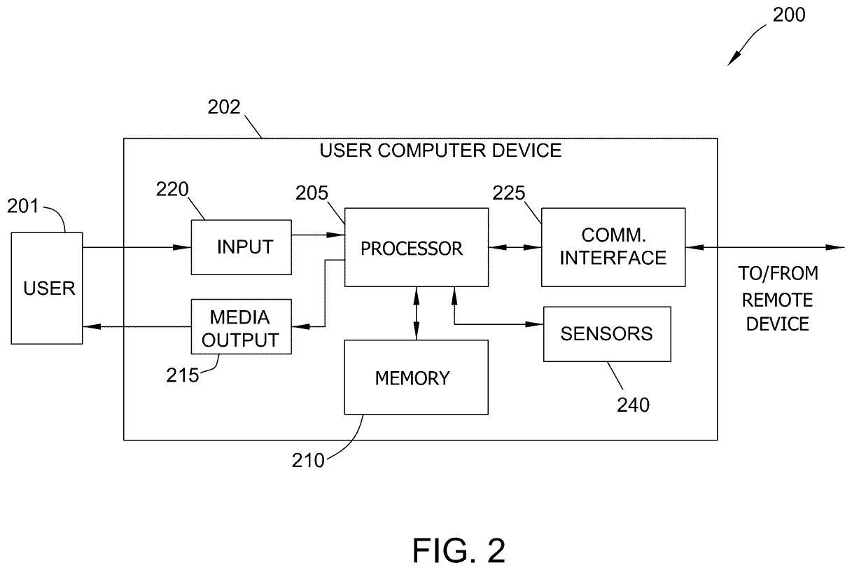

FIG. 2 depicts an exemplary client computing device 202. Client computing device 202 may be, for example, at least one of user device 108, transportation device 110, and/or transportation service computing device 112 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In certain exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as server computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 240. Sensors 240 may include, for example, an accelerometer, a global positioning system (GPS), or a gyroscope. Sensors 240 may be used to collect telematics data, which may be transmitted by client computing device 202 a remote device such as server computing device 102 (shown in FIG. 1).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from server computing device 102 (shown in FIG. 1).

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

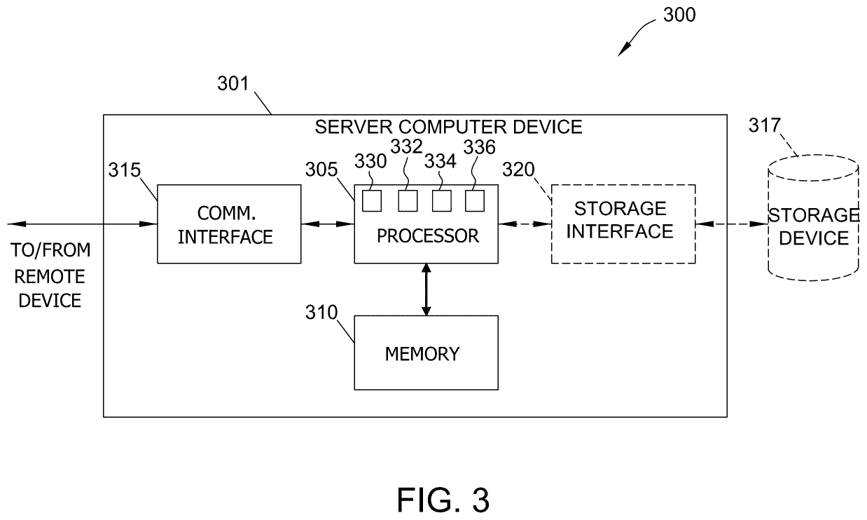

FIG. 3 depicts an exemplary server system that may be used with computer system 100 illustrated in FIG. 1. Server system 301 may be, for example, server computing device 102 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with user device 108 and/or transportation device 110 (all shown in FIG. 1), or another server system 301. For example, communication interface 315 may receive requests from user device 108 via the Internet. Further, processor 305, via communication interface 315, may be capable of causing funds to be transferred between various entities, such as, for example, accounts associated with user device 108 and/or transportation service computing device 112 (all shown in FIG. 1).

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

In exemplary embodiments, processor 305 may include and/or be communicatively coupled to one or more modules for implementing the systems and methods described herein. In some embodiments, processor 305 may include a communication module 330, which may be configured to: receive, from user device 108, a trip request including a destination location for a trip; retrieve one or more of geographic data, contextual data, and/or user profile data; cause user device 108 to display a user interface; cause user device 108 to display credentials associated with purchased transportation services; receive telematics data from user device 108 during a trip; receive group data from user device 108; and/or capture an image of one or more group members (e.g., using user device 108).

In some embodiments, processor 305 may include an analytics module 332, which may be configured to: generate a route based upon a trip request using an AI model; select a respective type of transportation for each of a plurality of route segments; generate a route to minimize one or more of a distance, a duration, a number of route segments, and/or a cost associated with a trip; train an AI model; generate a risk score associated with a generated route using an AI model; determine an insurance cost associated with a generated route based upon a generated risk score; and/or allocate a cost associated with a trip among one or more group members.

In some embodiments, processor 305 may further include a graphics module 334, which may be configured to generate a user interface, which may include instructions associated with a generated route that indicate the respective type of transportation to be used for each route segment.

In some embodiments, processor 305 may further include a funds transfer module 336, which may be configured to: automatically purchase transportation services associated with at least one of a plurality of route segments of a route; identify an account associated with each of one or more group members; and/or automatically transfer funds from identified accounts based upon an allocation of a cost among group members.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Transportation Device

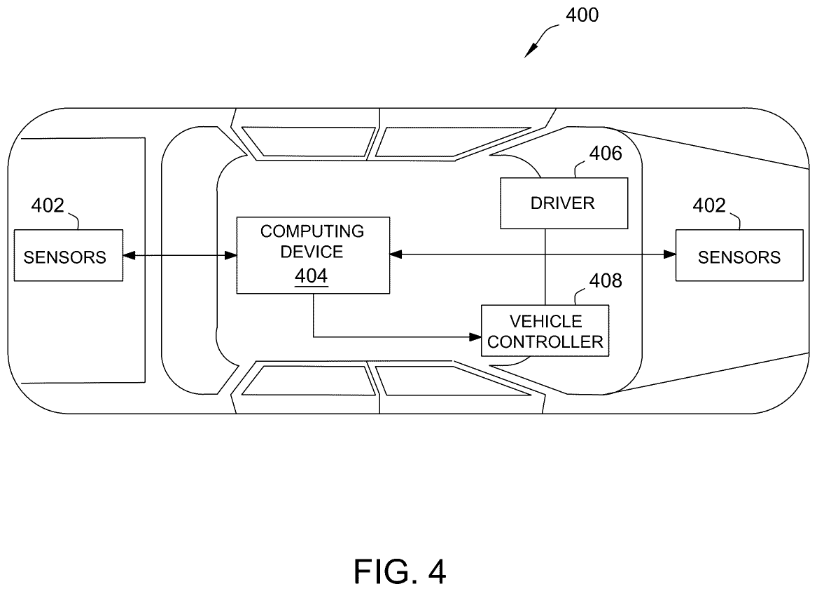

FIG. 4 depicts an exemplary transportation device 400. Transportation device 400 may be, for example, transportation device 110. In some embodiments, transportation device 400 may be a conventional and/or autonomous automobile, a motorcycle, a bicycle, a powered scooter (e.g., an electric scooter), a bus, a train, and/or another type of vehicle. Transportation device 400 may include a plurality of sensors 402 and a computing device 404. Sensors 402 may include, but are not limited to, temperature sensors, terrain sensors, weather sensors, accelerometers, gyroscopes, radar, LIDAR, Global Positioning System (GPS), video devices, imaging devices, cameras (e.g., 2D and 3D cameras), audio recorders, and computer vision. In some embodiments, sensors 402 may be used to collect, for example, vehicle telematics data, as described above. In addition, sensors 402 may be used to collect additional information, for example, whether any external devices (e.g., user device 108) are communicatively linked to and/or otherwise in proximity to transportation device 400.

Such telematics data and/or sensor data collected by sensors 402 may be transmitted to server computing device 102 (shown in FIG. 1). The telematics data may be transmitted, for example, via user device 108 (shown in FIG. 1), which may be communicatively linked to transportation device 400 (e.g., via a physical dock and/or a wireless connection).

Computing device 404 may be implemented, for example, as client computing device 202 (shown in FIG. 2). In exemplary embodiments, computing device 404 may receive data from sensors 402. In certain embodiments where server computing device 102 is remote from transportation device 400, computing device 404 may transmit data received from sensors 402 (e.g., vehicle telematics data) to server computing device 102. Alternatively, server computing device 102 may be implemented as computing device 404 and/or computing device 404 may execute some or all of the functions described with respect to server computing device 102.

In exemplary embodiments, vehicle controller 408 may control at least some operation of transportation device 400. For example, vehicle controller 408 may steer, accelerate, or decelerate transportation device 400 based upon data received, for example, from sensors 402. In some embodiments, vehicle controller 408 may include a display screen or touchscreen (not shown) that is capable of displaying information to and/or receiving input from driver 406.

In other embodiments, vehicle controller 408 may be capable of wirelessly communicating with a user mobile device such as user device 108 in transportation device 400. In these embodiments, vehicle controller 408 may be capable of communicating with the user of user device 108, such as driver 406, through an application on user device 108. In some embodiments, computing device 404 may include vehicle controller 408.

### Exemplary Method for Automated Route Generation

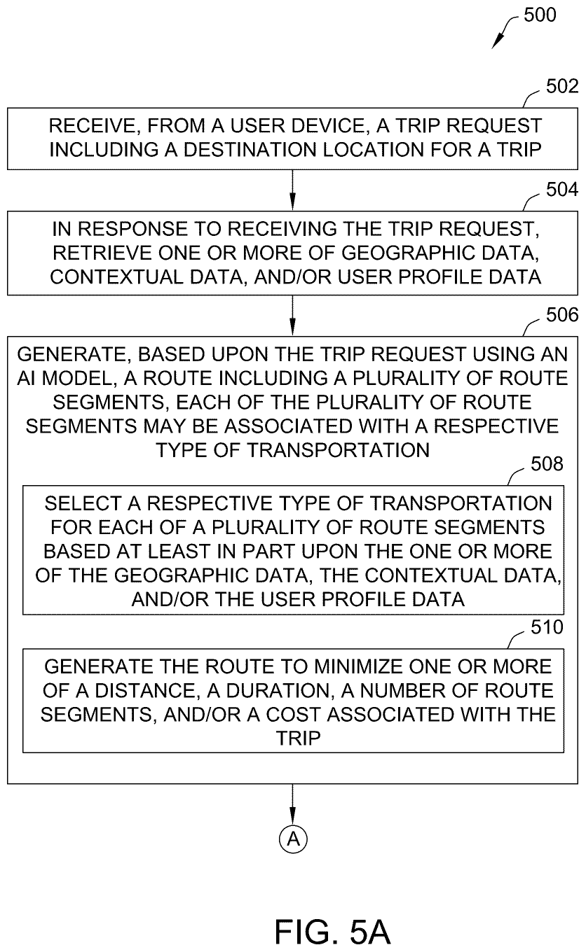

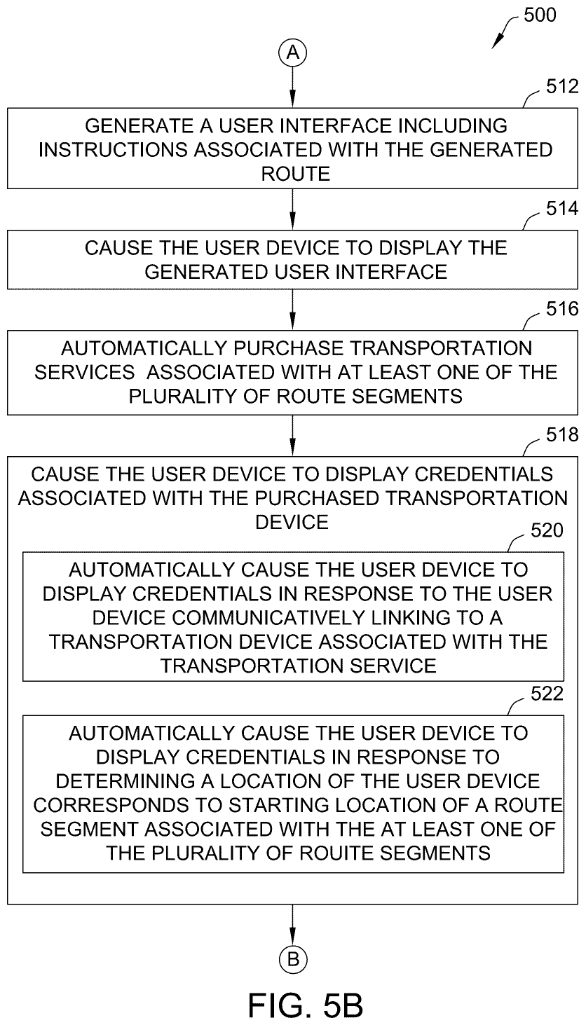

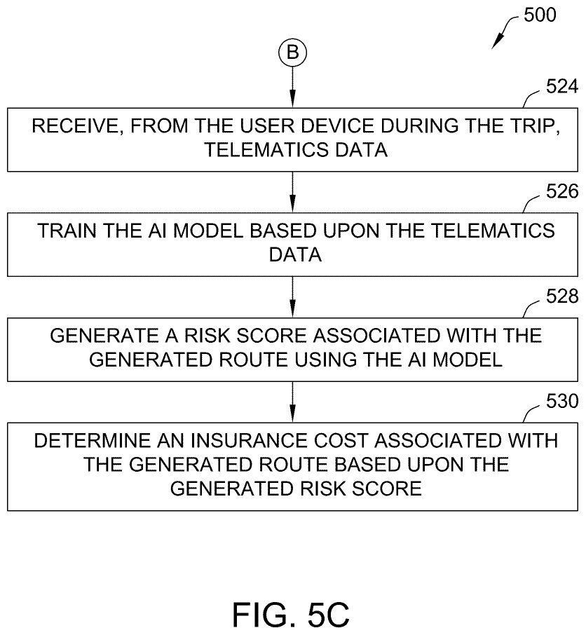

FIGS. 5A, 5B, and 5C are flowcharts that illustrate an exemplary computer-implemented method 500 for automated route generation. Computer-implemented method 500 may be performed by one or more components of computer system 100 (shown in FIG. 1), such as server computing device 102.

In the exemplary embodiment, computer-implemented method 500 may include receiving 502, from a user device (such as user device 108 shown in FIG. 1), a trip request including a destination location for a trip. In some embodiments, receiving 502 the trip request may be performed by server computing device 102, for example, by executing communication module 330 (shown in FIG. 3).

In some embodiments, computer-implemented method 500 may further include, in response to receiving the trip request, retrieving 504 one or more of geographic data, contextual data, and/or user profile data (described above with respect to FIG. 1). The route may be generated based at least in part upon the one or more of the geographic data, the contextual data, and/or the user profile data. In some embodiments, retrieving 504 tone or more of geographic data, contextual data, and/or user profile data may be performed by server computing device 102, for example, by executing communication module 330 (shown in FIG. 3).

In the exemplary embodiment, computer-implemented method 500 may further include generating 506, based upon the trip request using an AI model, a route including a plurality of route segments. Each of the plurality of route segments may be associated with a respective type of transportation. The AI model may be trained using historical trip records including historical trip data associated with historical trips. In some embodiments, the historical trip data includes one or more of historical destinations, historical routes, historical types of transportation used, historical costs, user feedback, and/or historical events associated with historical trips. In some embodiments, generating 506 the route may be performed by server computing device 102, for example, by executing analytics module 332 (shown in FIG. 3).

In some embodiments, computer-implemented method 500 may further include selecting 508 a respective type of transportation for each of a plurality of route segments based at least in part upon the one or more of the geographic data, the contextual data, and/or the user profile data. In some embodiments, selecting 508 the respective types of transportation may be performed by server computing device 102, for example, by executing analytics module 332 (shown in FIG. 3).

In some embodiments, computer-implemented method 500 may further include generating 510 the route to minimize one or more of a distance, a duration, a number of route segments, and/or a cost associated with the trip. In some embodiments, generating 510 the route may be performed by server computing device 102, for example, by executing analytics module 332 (shown in FIG. 3).

In the exemplary embodiment, computer-implemented method 500 may further include generating 512 a user interface. The user interface may include instructions associated with the generated route. The instructions may indicate the respective type of transportation to be used for each route segment. In some embodiments, generating 512 the user interface may be performed by server computing device 102, for example, by executing graphics module 334 (shown in FIG. 3).

In the exemplary embodiment, computer-implemented method 500 may further include causing 514 the user device to display the generated user interface. In some embodiments, causing 514 the user device to display the user interface may be performed by server computing device 102, for example, by executing communication module 330 (shown in FIG. 3).

In some embodiments, computer-implemented method 500 may further include automatically purchasing 516 transportation services associated with at least one of the plurality of route segments. In some embodiments, automatically purchasing 516 the transportation services may be performed by server computing device 102, for example, by funds transfer module 336 (shown in FIG. 3).

In such embodiments, computer-implemented method 500 may further include causing 518 the user device to display credentials associated with the purchased transportation services. In some such embodiments, computer-implemented method 500 may include automatically causing 520 the user device to display credentials in response to the user device communicatively linking to a transportation device associated with the transportation service. Additionally or alternatively, in some such embodiments, computer-implemented method 500 may include automatically causing 522 the user device to display credentials in response to determining a location of the user device corresponds to starting location of a route segment associated with the at least one of the plurality of route segments. In some embodiments, causing 518 the user device to display credentials may be performed by server computing device 102, for example, by executing communication module 330 (shown in FIG. 3).

In some embodiments, computer-implemented method 500 may further include receiving 524, from the user device during the trip, telematics data. In some such embodiments, the telematics data may be generated by at least one sensor of the user device. Additionally or alternatively, in some such embodiments, the user device may be configured to communicatively pair with a transportation device, and the telematics data may be generated by at least one sensor of the transportation device. In some embodiments, receiving 524 the telematics data may be performed by server computing device 102, for example, by executing communication module 330 (shown in FIG. 3).

In such embodiments, computer-implemented method 500 may further include further training 526 the AI model based upon the telematics data. In some embodiments, training 526 the AI model may be performed by server computing device 102, for example, by executing analytics module 332 (shown in FIG. 3).

In some embodiments, computer-implemented method 500 may further include generating 528 a risk score associated with the generated route using the AI model. In some embodiments, generating 528 the risk score may be performed by server computing device 102, for example, by executing analytics module 332 (shown in FIG. 3).

In such embodiments, computer-implemented method 500 may further include determining 530 an insurance cost associated with the generated route based upon the generated risk score. In some embodiments, determining 530 the insurance cost may be performed by server computing device 102, for example, by executing analytics module 332 (shown in FIG. 3).

### Exemplary Method for Group-Based Trip Management

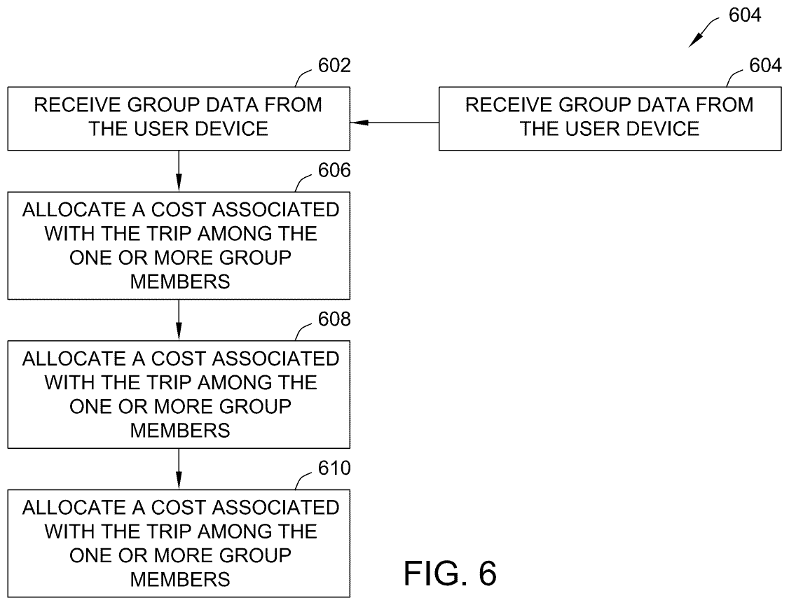

FIG. 6 is a flowchart that illustrates an exemplary computer-implemented method 600 for group-based trip management. Computer-implemented method 600 may be performed by one or more components of computer system 100 (shown in FIG. 1), such as server computing device 102.

In the exemplary embodiment, computer-implemented method 600 may include receiving 602 group data from the user device. The group data may identify one or more group members intending to travel together on a trip. In some embodiments, receiving 602 the group data may be performed by server computing device 102, for example, by executing communication module 330 (shown in FIG. 3).

In some embodiments, method 600 may further include capturing 604 an image of the one or more group members (e.g., using the user device). The group data may include the captured image. In some embodiments, capturing 604 the image may be performed by server computing device 102, for example, by executing communication module 330 (shown in FIG. 3).

In the exemplary embodiment, computer-implemented method 600 may further include allocating 606 a cost associated with the trip among the one or more group members. In some embodiments, allocating 606 the cost may be performed by server computing device 102, for example, by executing analytics module 332 (shown in FIG. 3).

In the exemplary embodiment, computer-implemented method 600 may further include identifying 608 an account associated with each of the one or more group members. In some embodiments, identifying 608 the account may be performed by server computing device 102, for example, by executing funds transfer module 336 (shown in FIG. 3).

In the exemplary embodiment, computer-implemented method 600 may further include automatically transferring 610 funds from the identified accounts based upon the allocation of the cost. In some embodiments, automatically transferring 610 the funds may be performed by server computing device 102, for example, by executing funds transfer module 336 (shown in FIG. 3).

### Exemplary Embodiments

In an exemplary embodiment, a computing device may be provided. The computing device may include at least one processor in communication with at least one memory device and with a user device corresponding to a user. The at least one processor may be configured to receive, from the user device, a trip request including a destination location for a trip. The at least one processor may be further configured to generate, based upon the trip request using an AI model, a route including a plurality of route segments. Each of the plurality of route segments may be associated with a respective type of transportation. The AI model may be trained using historical trip records including historical trip data associated with historical trips. The at least one processor may be further configured to generate a user interface. The user interface may include instructions associated with the generated route. The instructions may indicate the respective type of transportation to be used for each route segment. The at least one processor may be further configured to cause the user device to display the generated user interface. The computing device may perform additional, less, or alternate functionality, including that discussed elsewhere herein.

In certain embodiments, the at least one processor may be further configured to, in response to receiving the trip request, retrieve one or more of geographic data, contextual data, and/or user profile data, wherein the route is generated based at least in part upon the one or more of the geographic data, the contextual data, and/or the user profile data.

In some such embodiments, the at least one processor may be further configured to select the respective type of transportation for each of the plurality of route segments based at least in part upon the one or more of the geographic data, the contextual data, and/or the user profile data.

In certain embodiments, the at least one processor may be further configured to generate the route to minimize one or more of a distance, a duration, a number of route segments, and/or a cost associated with the trip.

In some embodiments, the historical trip data may include one or more of historical destinations, historical routes, historical types of transportation used, historical costs, user feedback, and/or historical events associated with historical trips.

In certain embodiments, the at least one processor may be further configured to automatically purchase transportation services associated with at least one of the plurality of route segments.

In some such embodiments, the at least one processor may be further configured to cause the user device to display credentials associated with the purchased transportation services.

In certain such embodiments, the at least one processors may be further configured to automatically cause the user device to display credentials in response to the user device communicatively linking to a transportation device associated with the transportation service.

In some such embodiments, the at least one processors may be further configured to automatically cause the user device to display credentials in response to determining a location of the user device corresponds to starting location of a route segment associated with the at least one of the plurality of route segments.

In certain embodiments, the at least one processor may be further configured to receive, from the user device during the trip, telematics data and further train the AI model based upon the telematics data.

In some such embodiments, the telematics data may be generated by at least one sensor of the user device.

In certain such embodiments, wherein the user device may be configured to communicatively pair with a transportation device, and the telematics data may be generated by at least one sensor of the transportation device.

In some embodiments, wherein the at least one processor may be further configured to generate a risk score associated with the generated route using the AI model.

In certain such embodiments, the at least one processor may be further configured to determine an insurance cost associated with the generated route based upon the generated risk score.

In some embodiments, the at least one processor may be further configured to receive group data from the user device, the group data identifying one or more group members and allocate a cost associated with the trip among the one or more group members.

In certain such embodiments, the at least one processor may be further configured to cause the user device to capture an image of the one or more group members, and the group data may include the captured image.

In some such embodiments, the at least one processor may be further configured to identify an account associated with each of the one or more group members and automatically transfer funds from the identified accounts based upon the allocation of the cost.

In another exemplary embodiment, a computer-implemented method for automated route generation may be provided. The computer-implemented method may be performed by a computing device including at least one processor in communication with at least one memory device and with a user mobile device corresponding to a user. The computer-implemented method may include receiving, from the user device, a trip request including a destination location for a trip. The computer-implemented method may further include generating, based upon the trip request using an AI model, a route including a plurality of route segments. Each of the plurality of route segments may be associated with a respective type of transportation. The AI model may be trained using historical trip records including historical trip data associated with historical trips. The computer-implemented method may further include generating a user interface. The user interface may include instructions associated with the generated route. The instructions may indicate the respective type of transportation to be used for each route segment. The computer-implemented method may further include causing the user device to display the generated user interface. The computer-implemented method may include additional, less, or alternate functionality, including that discussed elsewhere herein.

In certain embodiments, the computer-implemented method may further include, in response to receiving the trip request, retrieve one or more of geographic data, contextual data, and/or user profile data, wherein the route is generated based at least in part upon the one or more of the geographic data, the contextual data, and/or the user profile data.

In some such embodiments, the computer-implemented method may further include selecting the respective type of transportation for each of the plurality of route segments based at least in part upon the one or more of the geographic data, the contextual data, and/or the user profile data.

In certain embodiments, the computer-implemented method may further include generating the route to minimize one or more of a distance, a duration, a number of route segments, and/or a cost associated with the trip.

In some embodiments, the historical trip data may include one or more of historical destinations, historical routes, historical types of transportation used, historical costs, user feedback, and/or historical events associated with historical trips.

In certain embodiments, the computer-implemented method may further include automatically purchasing transportation services associated with at least one of the plurality of route segments.

In some such embodiments, the computer-implemented method may further include causing the user device to display credentials associated with the purchased transportation services.

In certain such embodiments, the computer-implemented method may further include automatically causing the user device to display credentials in response to the user device communicatively linking to a transportation device associated with the transportation service.

In some such embodiments, the computer-implemented method may further include automatically causing the user device to display credentials in response to determining a location of the user device corresponds to starting location of a route segment associated with the at least one of the plurality of route segments.

In certain such embodiments, the computer-implemented method may further include receiving, from the user device during the trip, telematics data and further training the AI model based upon the telematics data.

In some such embodiments, the telematics data may be generated by at least one sensor of the user device.

In certain such embodiments, the user device may be configured to communicatively pair with a transportation device, and the telematics data may be generated by at least one sensor of the transportation device.

In some embodiments, the computer-implemented method may further include generating a risk score associated with the generated route using the AI model.

In certain such embodiments, the computer-implemented method may further include determining an insurance cost associated with the generated route based upon the generated risk score.

In some embodiments, the computer-implemented method may further include receiving group data from the user device, the group data identifying one or more group members and allocating a cost associated with the trip among the one or more group members.

In certain such embodiments, the computer-implemented method may further include causing the user device to capture an image of the one or more group members, and the group data may include the captured image.

In some such embodiments, the computer-implemented method may further include identifying an account associated with each of the one or more group members and automatically transferring funds from the identified accounts based upon the allocation of the cost.

In another exemplary embodiment, at least one non-transitory computer-readable storage media having computer-executable instructions embodied thereon may be provided. When executed by a computing device including at least one processor in communication with at least one memory device and with a user device corresponding to a user, the computer-executable instructions may cause the at least one processor to receive, from the user device, a trip request including a destination location for a trip. The computer-executable instructions may further cause the at least one processor to generate, based upon the trip request using an AI model, a route including a plurality of route segments. Each of the plurality of route segments may be associated with a respective type of transportation. The AI model may be trained using historical trip records including historical trip data associated with historical trips. The computer-executable instructions may further cause the at least one processor to generate a user interface. The user interface may include instructions associated with the generated route. The instructions may indicate the respective type of transportation to be used for each route segment. The computer-executable instructions may further cause the at least one processor to cause the user device to display the generated user interface. The computer-executable instructions may direct additional, less, or alternate functionality, including that discussed elsewhere herein.

In certain embodiments, the computer-executable instructions may further cause at least one processor to, in response to receiving the trip request, retrieve one or more of geographic data, contextual data, and/or user profile data, wherein the route is generated based at least in part upon the one or more of the geographic data, the contextual data, and/or the user profile data.

In some such embodiments, the computer-executable instructions may further cause the at least one processor to select the respective type of transportation for each of the plurality of route segments based at least in part upon the one or more of the geographic data, the contextual data, and/or the user profile data.

In certain embodiments, the computer-executable instructions may further cause the at least one processor to generate the route to minimize one or more of a distance, a duration, a number of route segments, and/or a cost associated with the trip.

In some embodiments, the historical trip data may include one or more of historical destinations, historical routes, historical types of transportation used, historical costs, user feedback, and/or historical events associated with historical trips.

In certain embodiments, the computer-executable instructions may further cause the at least one processor to automatically purchase transportation services associated with at least one of the plurality of route segments.

In some such embodiments, the computer-executable instructions may further the at least one processor to cause the user device to display credentials associated with the purchased transportation services.

In certain such embodiments, the computer-executable instructions may further cause the at least one processor to automatically cause the user device to display credentials in response to the user device communicatively linking to a transportation device associated with the transportation service.

In some such embodiments, the computer-executable instructions may further cause the at least one processor to automatically cause the user device to display credentials in response to determining a location of the user device corresponds to starting location of a route segment associated with the at least one of the plurality of route segments.

In certain embodiments, the computer-executable instructions may further cause the at least one processor to receive, from the user device during the trip, telematics data and further train the AI model based upon the telematics data.

In some such embodiments, the telematics data may be generated by at least one sensor of the user device.

In certain such embodiments, the user device may be configured to communicatively pair with a transportation device, and the telematics data may be generated by at least one sensor of the transportation device.

In some embodiments, the computer-executable instructions may further cause the at least one processor to generate a risk score associated with the generated route using the AI model.

In certain such embodiments, the computer-executable instructions may further cause the at least one processor to determine an insurance cost associated with the generated route based upon the generated risk score.

In some embodiments, the computer-executable instructions may further cause the at least one processor to receive group data from the user device, the group data identifying one or more group members and allocate a cost associated with the trip among the one or more group members.

In certain such embodiments, the computer-executable instructions may further cause the at least one processor to cause the user device to capture an image of the one or more group members, and the group data may include the captured image.

In some such embodiments, the computer-executable instructions may further cause the at least one processor to identify an account associated with each of the one or more group members and automatically transfer funds from the identified accounts based upon the allocation of the cost.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, server computing device 102 is configured to implement machine learning, such that server computing device 102 “learns” to analyze, organize, and/or process data without being explicitly programmed. Machine learning may be implemented through machine learning (“ML”) methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to telematics data and user input received from user device 108 and/or transportation device 110. ML outputs may include but are not limited to insurance premium amounts calculated based upon the received telematics data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of conversation data with known characteristics or features. Such information may include, for example, information associated with a plurality of different speaking styles and accents.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing telematics data. For example, the processing element may learn, with the user's permission or affirmative consent, to identify an amount of risk associated with the user's actual transportation behavior. This information may be used to calculate an insurance premium based upon the user's transportation activity.

In some embodiments, the voice bots or chatbots discussed herein may be configured to utilize AI and/or ML techniques. For instance, the voice bot or chatbot may be a ChatGPT chatbot. The voice bot or chatbot may employ supervised or unsupervised machine learning techniques, which may be followed by and/or used in conjunction with reinforced or reinforcement learning techniques. The voice bot or chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot or chatterbot is a software application used to conduct an online chat conversation via text or text-to-speech, in lieu of providing direct contact with a live human agent. Chatbots are computer programs that are capable of maintaining a conversation with a user in natural language, understanding their intent, and replying based on preset rules and data, and may be designed to convincingly simulate the way a human would behave as a conversational partner.

Chatbots are used in dialog systems for various purposes including customer service, request routing, or information gathering. While some chatbot applications use extensive word-classification processes, natural-language processors, and sophisticated AI, others simply scan for general keywords and generate responses using common phrases obtained from an associated library or database.

Most chatbots are accessed on-line via website popups or through virtual assistants. They can be classified into usage categories that include: commerce (e-commerce via chat), education, entertainment, finance, health, news, and productivity.

For the purposes of this discussion, ChatGPT is an artificial intelligence chatbot. It is built on a family of large language models and has been fine-tuned (an approach to transfer learning) using both supervised and reinforcement learning techniques. ChatGPT is a member of the generative pre-trained transformer (GPT) family of language models. It was fine-tuned (an approach to transfer learning) over previous versions. The fine-tuning process leveraged both supervised learning as well as reinforcement learning in a process called reinforcement learning from human feedback (RLHF). Both approaches used human trainers to improve the model's performance. In the case of supervised learning, the model was provided with conversations in which the trainers played both sides: the user and the AI assistant. In the reinforcement learning step, human trainers first ranked responses that the model had created in a previous conversation. These rankings were used to create ‘reward models’ that the model was further fine-tuned on using several iterations of Proximal Policy Optimization (PPO). Proximal Policy Optimization algorithms present a cost-effective benefit to trust region policy optimization algorithms; they negate many of the computationally expensive operations with faster performance. In addition, chatbots similar to and including ChatGPT continue to gather data from users that could be used to further train and fine-tune the chatbot. Users can upvote or downvote responses they receive from ChatGPT and fill out a text field with additional feedback. The reward model of ChatGPT, designed around human oversight, can be over-optimized and thus hinder performance.

Although the core function of a chatbot is to mimic a human conversationalist, ChatGPT represents a type of chatbot that is versatile. For example, it can write and debug computer programs, compose music, teleplays, fairy tales, and student essays; answer test questions (sometimes, depending on the test, at a level above the average human test-taker); write poetry and song lyrics; emulate a Linux system; simulate an entire chat room; play games like tic-tac-toe; and simulate an ATM. ChatGPT training data includes many pages and information about internet phenomena and programming languages, such as bulletin board systems and the Python programming language.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computing device comprising at least one processor in communication with at least one memory device and with a user device corresponding to a user, the at least one processor configured to:
receive, from the user device, a trip request including a destination location for a trip;
generate, based upon the trip request using an artificial intelligence (AI) model, a route including a plurality of route segments, each of the plurality of route segments associated with a respective type of transportation, wherein the AI model is trained using historical trip records including historical trip data associated with historical trips;
generate a user interface, the user interface including instructions associated with the generated route, the instructions indicating the respective type of transportation to be used for each route segment; and
cause the user device to display the generated user interface.

2. The computing device of claim 1, wherein the at least one processor is further configured to, in response to receiving the trip request, retrieve one or more of geographic data, contextual data, and/or user profile data, wherein the route is generated based at least in part upon the one or more of the geographic data, the contextual data, and/or the user profile data.

3. The computing device of claim 2, wherein the at least one processor is further configured to select the respective type of transportation for each of the plurality of route segments based at least in part upon the one or more of the geographic data, the contextual data, and/or the user profile data.

4. The computing device of claim 1, wherein the at least one processor is further configured to generate the route to minimize one or more of a distance, a duration, a number of route segments, and/or a cost associated with the trip.

5. The computing device of claim 1, wherein the historical trip data includes one or more of historical destinations, historical routes, historical types of transportation used, historical costs, user feedback, and/or historical events associated with historical trips.

6. The computing device of claim 1, wherein the at least one processor is further configured to automatically purchase transportation services associated with at least one of the plurality of route segments.

7. The computing device of claim 6, wherein the at least one processor is further configured to cause the user device to display credentials associated with the purchased transportation services.

8. The computing device of claim 6, wherein the at least one processors is further configured to automatically cause the user device to display credentials in response to the user device communicatively linking to a transportation device associated with the transportation service.

9. The computing device of claim 6, wherein the at least one processors is further configured to automatically cause the user device to display credentials in response to determining a location of the user device corresponds to starting location of a route segment associated with the at least one of the plurality of route segments.

10. The computing device of claim 1, wherein the at least one processor is further configured to:
receive, from the user device during the trip, telematics data; and
further train the AI model based upon the telematics data.

11. The computing device of claim 10, wherein the telematics data is generated by at least one sensor of the user device.

12. The computing device of claim 10, wherein the user device is configured to communicatively pair with a transportation device, and wherein the telematics data is generated by at least one sensor of the transportation device.

13. The computing device of claim 1, wherein the at least one processor is further configured to generate a risk score associated with the generated route using the AI model.

14. The computing device of claim 13, wherein the at least one processor is further configured to determine an insurance cost associated with the generated route based upon the generated risk score.

15. The computing device of claim 1, wherein the at least one processor is further configured to:
receive group data from the user device, the group data identifying one or more group members; and
allocate a cost associated with the trip among the one or more group members.

16. The computing device of claim 15, wherein the at least one processor is further configured to cause the user device to capture an image of the one or more group members, and wherein the group data includes the captured image.

17. The computing device of claim 15, wherein the at least one processor is further configured to:
identify an account associated with each of the one or more group members; and
automatically transfer funds from the identified accounts based upon the allocation of the cost.

18. A computer-implemented method for automated route generation,
the computer-implemented method performed by a computing device including at least one processor in communication with at least one memory device and with a user mobile device corresponding to a user, said computer-implemented method comprising:
receiving, from the user device, a trip request including a destination location for a trip;
generating, based upon the trip request using an artificial intelligence (AI) model, a route including a plurality of route segments, each of the plurality of route segments associated with a respective type of transportation, wherein the AI model is trained using historical trip records including historical trip data associated with historical trips;
generating a user interface, the user interface including instructions associated with the generated route, the instructions indicating the respective type of transportation to be used for each route segment; and
causing the user device to display the generated user interface.

19. The computer-implemented method of claim 18, further comprising, in response to receiving the trip request, retrieve one or more of geographic data, contextual data, and/or user profile data, wherein the route is generated based at least in part upon the one or more of the geographic data, the contextual data, and/or the user profile data.

20. At least one non-transitory computer-readable storage media having computer-executable instructions embodied thereon, wherein when executed by a computing device including at least one processor in communication with at least one memory device and with a user device corresponding to a user, the computer-executable instructions cause the at least one processor to:
receive, from the user device, a trip request including a destination location for a trip;
generate, based upon the trip request using an artificial intelligence (AI) model, a route including a plurality of route segments, each of the plurality of route segments associated with a respective type of transportation, wherein the AI model is trained using historical trip records including historical trip data associated with historical trips;
generate a user interface, the user interface including instructions associated with the generated route, the instructions indicating the respective type of transportation to be used for each route segment; and
cause the user device to display the generated user interface.
